(19) United States
(12) Patent Application Publication
(10) Pub. No.: US 2007/0180248 A1
(43) Pub. Date: Aug. 2, 2007

(54) Process for the authentication of products

(76) Inventors: Daniel Gorostidi, Ecublens (CH); Muriel Caraccia, Lausanne (CH); Charles-Paul Friden, Mont-sur-Lausanne (CH)

Correspondence Address: BAKER & DANIELS LLP, 300 NORTH MERIDIAN STREET, SUITE 2700, INDIANAPOLIS, IN, 46204, US

(21) Appl. No.: 10/592,850

(22) PCT Filed: Mar. 14, 2005
(86) PCT No.: PCT/IB05/00680

§ 371 Date: Sep. 14, 2006

(30) Foreign Application Priority Data
Mar. 17, 2004 (EP) 04405160.5

(51) Int. Cl. G06Q 99/00; H04L 9/00; H04K 1/00

(52) U.S. Cl. 713/173; 713/175; 713/156; 705/67; 713/176

(57) ABSTRACT

A process for the generation of product authentication certificates with steps for: the generation of data identifying each product in a unique manner and storage of these data in a product database of the computer system of a legitimate manufacturer; the storage of data confidential to each purchaser of products in a customer database; the entry and transmission by means of a global computer network, such as the Internet, during a purchase, of data identifying a product and a purchaser, in a server system for the generation of authenticity certificates; the verification, in the server system for the generation of authenticity certificates, of the validity of the data identifying the said product; the automatic selection, in the server system for the generation of authenticity certificates, of the information to be incorporated into the authenticity certificate print file, where this information includes confidential data associated with the said purchaser and the data identifying the said product in a unique manner; the generation of a print file of an image of the authenticity certificate with one part that is protected against illicit modification of the authenticity certificate, incorporating at least the said data identifying the said product in a unique manner, and another part that is encoded with the confidential data of the purchaser; and transmission of the print file to the point of sale of the product or a terminal of the purchaser.

This present invention concerns a process which is used to verify the authenticity of a product by the purchaser of this product.

Given the large number of counterfeit branded products, it would be advantageous to have the means by which the purchaser of these products could verify their authenticity. Furthermore, for the holders of intellectual property rights on branded products which are manufactured by approved manufacturers, it is necessary to be able to check that the approved manufacturers are placing on the market only products that are authentic and which have been declared to the rights holders.

There is no suitable system on the market which allows the purchaser to verify the authenticity of a product, meaning one which has been created by a legitimate or approved manufacturer and put onto the market with the agreement of the holder of the intellectual property rights. Presently, most branded products are identifiable by a product number, generally in the form of a barcode, enabling the manufacturer to identify the origin of the products. Nevertheless, many product codes are not unique to a single article, and even if they were, it would be possible for a counterfeiter to simply copy the articles and the product numbers from an authentic copy, in order to put multiples copies onto the market with no easy way of verifying that it is an authentic and authorised product. In the existing systems, the purchaser cannot, as a general rule, easily verify the authenticity of the product that he or she has purchased.

Patent application WO 01/97175 describes a process for the generation of home-printed tickets. The ticket includes a watermark which can be used to verify the authenticity of the ticket at the time of the check by the issuer of the ticket, in order to increase protection against fraud. The process described in this application cannot be used however for the generation of product authentication certificates by the purchaser. Firstly, the watermark cannot be read by the user of the ticket, but only by an optical reader, and secondly the authenticity of the source of the information contained in the ticket cannot be verified by the purchaser. The purchaser is unable to ascertain whether the ticket has been issued by the legitimate issuer or by a fraudulent intermediary.

WO 03/006257 describes processes for the generation of tickets or of other home-printable documents with a microstructure that provides protection against the fraudulent use of the printed image. The process described in this application cannot be used however for the generation of product authentication certificates. It does not mention the generation of authentication certificates enabling a purchaser to verify the authenticity of an associated product. The authenticity of the source of the information contained in the ticket cannot be verified by the purchaser, and he or she is unable to ascertain whether the ticket has been issued by the legitimate issuer or by a fraudulent intermediary.

US 2001/0041214 describes a process which can be used to verify the authenticity of a product by the purchaser, and to provide protection against the counterfeiting of products. In this process, a micro-encoded mark is placed on the product, in the form of an adhesive droplet for example, or an ink with microparticles. The mark or microparticle forms a unique design, which is stored in a database associated with the product. The unique design has to be read with a magnifier or other optical reading resource. The purchaser is able to compare the micro-encoded mark with the corresponding representation in the database, accessible via the Internet, to verify the authenticity. This process nevertheless has drawbacks. Firstly, it requires marking of the authentic product with an adhesive droplet or ink, which is not always desirable or possible. Furthermore, the database of the marks (microparticles) is accessible to everyone for all the products, which makes it even easier for the fraudsters who are able to create microcodes from images available on the Internet. This is made all the easier since the purchaser cannot necessarily know what to expect on seeing a microcode, and cannot necessarily distinguish between a fraudulent microcode and the authentic microcode.

In addition, in US 2001/0041214, a description is provided of the generation of labels that act as authenticity certificates which are protected against fraud (which are tamper-proof). Nevertheless, these labels accompany the product at the time of sale, and the purchaser is therefore unable, himself or herself, to perform a check on the authenticity of the product. A fraudster could prepare a microcode and an authenticity certificate and then sell them together.

In the light of the foregoing, one of the objectives of the invention is to propose a process that enables a purchaser to verify the authenticity of a product just purchased, with a high degree of reliability, and in particular to check that this product is not counterfeit and that it has been put onto the market with the authorisation of the legitimate manufacturer or the holder of the intellectual property rights.

It is advantageous to propose a process for the authentication of products which enables the holders of the intellectual property rights or the legitimate manufacturers to ensure that products put onto the market by an approved manufacturer are declared.

Likewise, it is advantageous to propose a process for reliable authentication process that is easy to implement and to use by manufacturers, approved distributors and purchasers.

The objective of the invention is attained by means of a process for the authentication of a product according to claim 1.

In the present invention, the product authentication process includes steps for:
the generation of data that uniquely identify and authenticate each product, and the storage of these data in a product database;
the storage of confidential data associated with each purchaser in a customer database;
the entry and transmission, by means of a global computer network such as the Internet, during a purchase, of data identifying a product and a purchaser in a server system for the generation of authenticity certificates;
verification of the validity of the data identifying the product, in the server system for the generation of authenticity certificates;
automatic selection, in the server system for the generation of authenticity certificates, of the information to be incorporated into the authenticity certificate print file, whereby this information includes the confidential data associated with the said purchaser and the data identifying the product in a unique manner;
the generation of an image of the authenticity certificate with one part that is protected against modification of the authenticity certificate, incorporating at least the said data identifying the said product in a unique manner, and another part that is encoded with the confidential data of the purchaser; and
sending the print file to the point of sale of the product or to a terminal of the purchaser.

The expression “protected against modification” means protected against the alteration or the use of information appearing on an authentic certificate in order to create a false certificate in an illicit manner.

The data identifying each product in a unique manner preferably includes a unique product identification number, and a validity code associated with this identification number generated and stored in the computer system of the legitimate manufacturer when the manufacture of the product is declared.

The information incorporated into the part that is protected against modification of the authenticity certificate preferably includes data allowing identification of the distributor of the product in addition to the data identifying the product.

The protected part of the image of the authenticity certificate can advantageously be in the form of a microstructure with a background image, preferably a photographic representation of the product, patterned by microstructure elements with written data identifying the product in a unique manner. The microstructure elements can also include information identifying the purchaser.

The microstructured part in particular constitutes protection against modification, that is against an attempt to create a certificate, in an illicit manner, for a product B from an authentic certificate for a product A. The protection against duplication comes particularly from the encoded part with information on the purchaser. In fact, it is useless to duplicate a certificate intended for purchaser A, since it cannot be supplied to purchaser B. Duplication of the certificate would be of some use to a counterfeiter who had copied products which are all based on the same authentic product number.

The entry of data identifying the product can be accomplished by means of a label accompanying the product, bearing a barcode that includes at least the unique product identification number and the associated validity code.

The label is preferably printed on paper that has been made secure by means of a watermark or iridescent ink.

In a first form of implementation, generation from the encoded part of the authenticity certificate includes the generation of a moiré pattern, with the encoded part being readable by means of a complementary transparent “revealer”, which is only in the possession of the purchaser and whose confidential content varies from one purchaser to the next. Advantageously, the moiré parameters are unique to each certificate, and are generated and stored in the computer system of the legitimate manufacturer. There are essentially two types of parameter. The first type of parameter, hereinafter called the transformation function, determines the shape of the moiré pattern. It is associated with the revealer and the purchaser. This parameter is not necessarily unique to each purchaser, as long as the probability that two different purchasers have the same set of parameters is low. The second type of parameter determines the content of the moiré pattern. For example, it can be a confidential word specified by the purchaser. It is also possible to include in the encoded part a combination of this confidential word and the number of the purchased product, which would enable this information to be made specific to each purchase.

The parameters for generation of the revealer can be generated at any time after receiving the personal data of the purchaser, such as in the context of a customer loyalty programme, in order to allow the printing and the transmission of the revealer to the purchaser independently of the printing certificate. The parameters for the encoded part of the certificate are preferably generated at the time of certificate generation, on the basis of the moiré parameters used for the complementary revealer.

In a variant, the encoded part of the authenticity certificate can be generated in the form of a visual cryptographic structure, with the encoded part being readable by means of a complementary revealer. As for the preceding variant, the visual cryptographic parameters are unique to each certificate and are generated and stored in the computer system of the legitimate manufacturer. The parameters for revealer generation can be generated at any time after receiving the personal data of the purchaser, while the parameters for the encoded part of the certificate are preferably generated at the time of certificate generation, on the basis of the cryptography parameters used for the complementary revealer.

Advantageously, in the aforementioned two variants, a single personal revealer can be used to decode several certificates of a purchaser of several products, while a certificate can be decoded only by a single revealer.

During the generation and storage of data identifying each purchaser in the customer database, parameters for generation of the moiré pattern or visual cryptography structures are generated and stored in the database, these parameters being used for the generation and printing of the revealer transmitted to the purchaser.

In another variant, the encoded part of the authenticity certificate can include a code corresponding to a code reproduced on a printed table transmitted to the purchaser, with the data of the table being stored in the customer database of the computer system. The content of the table is specific to the purchaser and is known only to the latter.

Other objectives and advantageous aspects of the invention will emerge from the claims, the description and of the appended figures, in which:

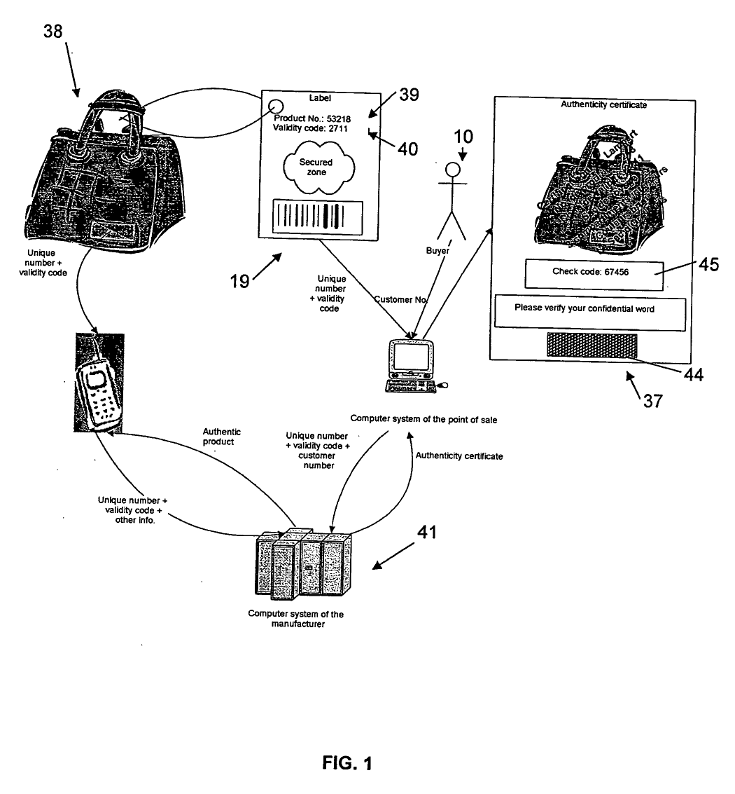

FIG. 1 is a diagram illustrating the general steps for the generation of an authenticity certificate according to the invention;

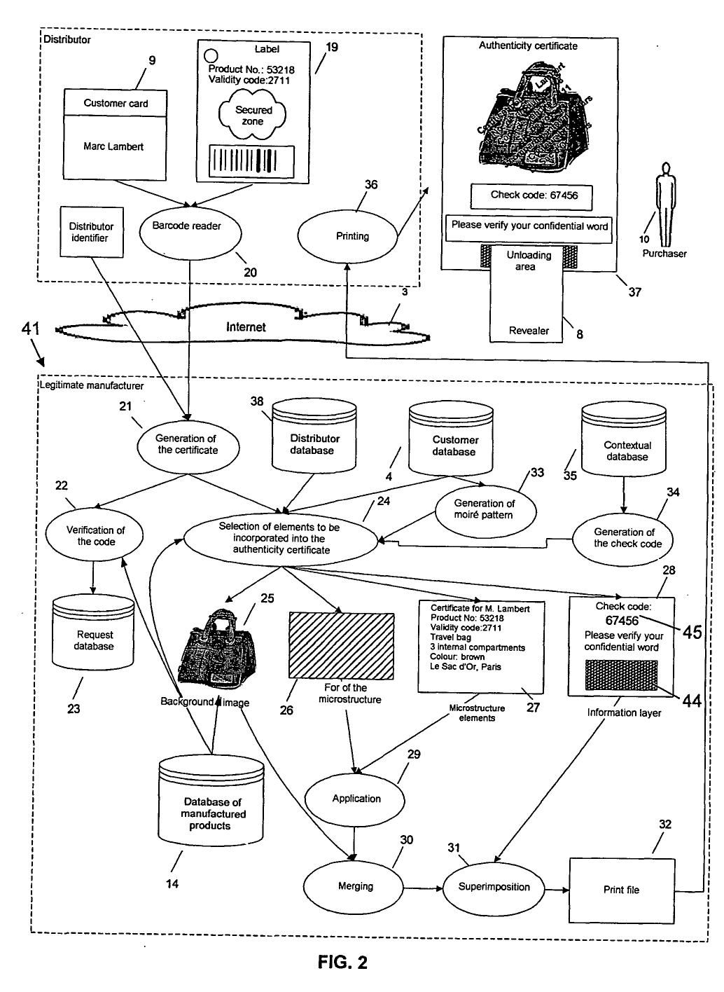

FIG. 2 is a diagram illustrating the more specific steps for the generation of an authenticity certificate according to the invention;

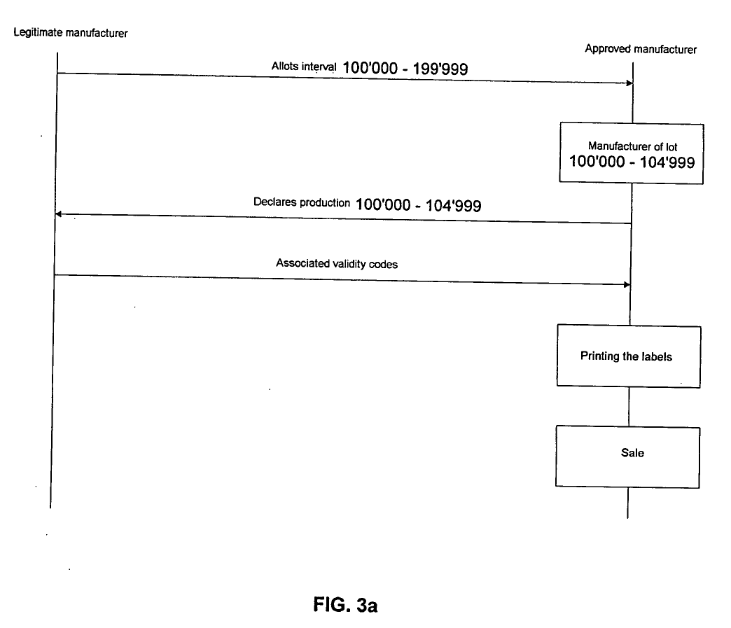

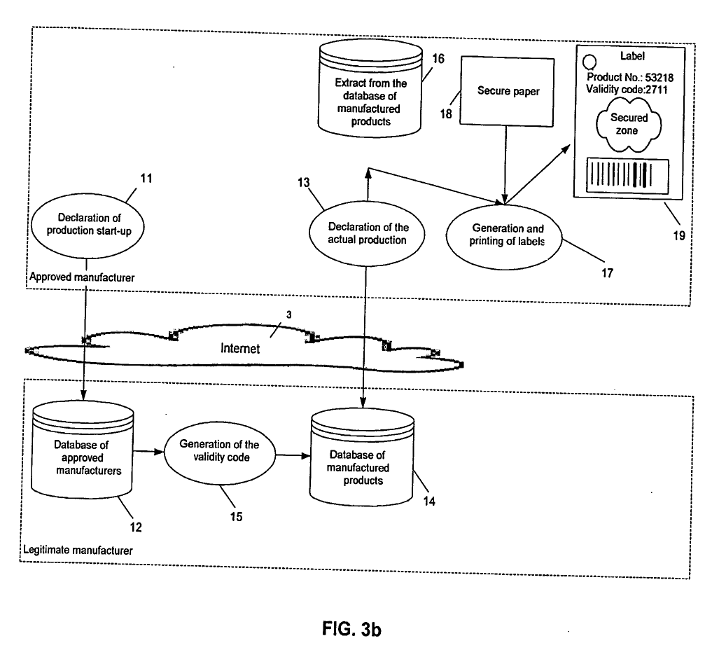

FIG. 3a is a diagram illustrating the steps for the allocation of product identification numbers for the generation of product identification labels according to the invention, used during the generation of authentication certificates;

FIG. 3b is a diagram illustrating the steps for the generation of product identification labels according to the invention, with the labels indicating a product identification number and an associated validity code used during the generation of an authentication certificate;

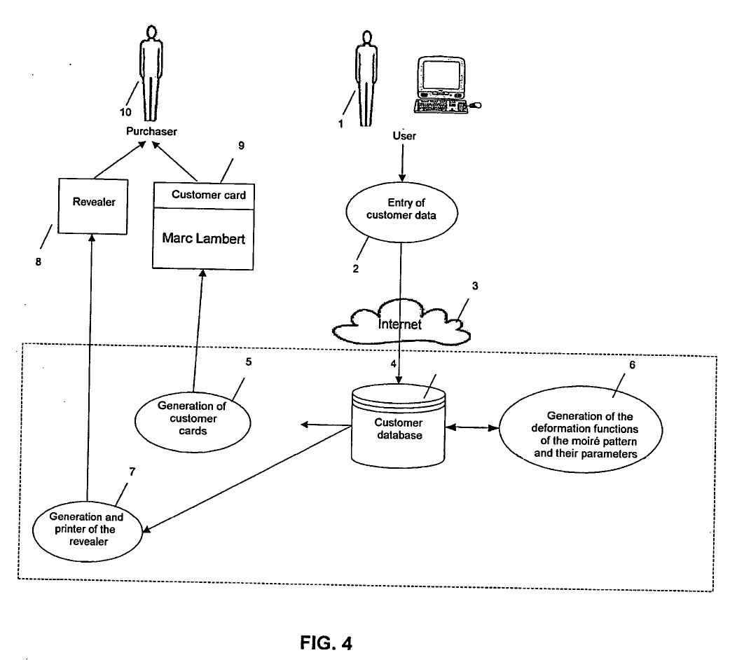

FIG. 4 is a diagram illustrating the steps for the creation of purchaser personal database according to the invention; and

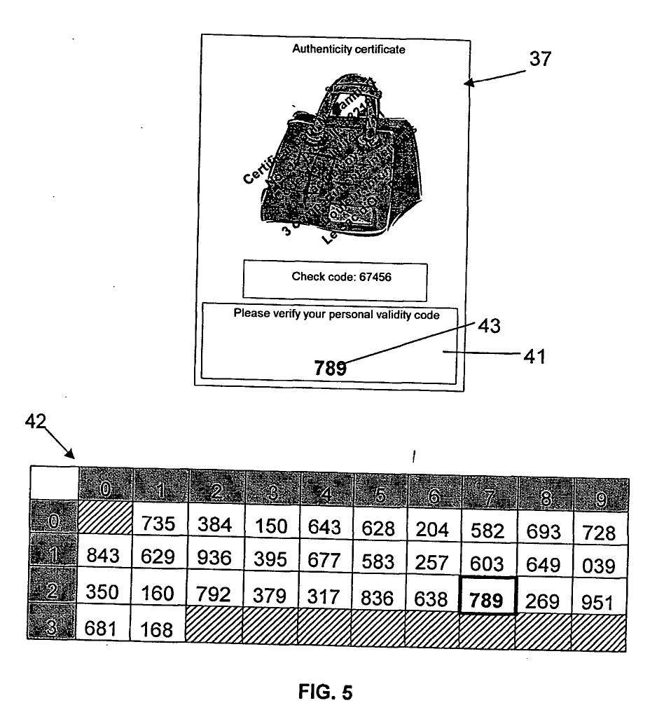

FIG. 5 illustrates a check table used by a purchaser to verify the validity of the authenticity certificate according to a second form of implementation of the invention.

Referring to the figures, and in particular FIGS. 1 and 2, a purchaser 10 of a product 38 can verify the authenticity of the product by means of an authenticity certificate 37 that is printable at the point of sale of the product at the time of purchase, or at home after the purchase. An authenticity certificate print file is generated in a computer system 41 approved by, or under the control of, the legitimate manufacturer of authentic products. By legitimate manufacturer is meant the holder of the intellectual property rights and of the manufacturing rights of the authentic product. The certificate is generated by the computer system of the manufacturer from a unique product identification number 39, a validity code 40 associated with the identification number of the product, and data concerning the customer. The computer system 41 of the legitimate manufacturer refuses to generate a certificate if the identification number of the product does not exist or has already been used for the generation of a certificate, or if the validity code is false. Preferably, data identifying the distributor are also included in the certificate generation. Transmission of the aforementioned data to the computer system of the manufacturer, and transmission of the certificate print file to the location of the purchaser, can be accomplished over a global communication network, such as the network known as the Internet 3.

The authenticity certificate of an authentic product includes information identifying the product and encoded information that can be verified only by the purchaser. Preferably, the certificate also contains personal information identifying the purchaser. The personalisation certificate removes the usefulness of generating copies of the certificate by counterfeiters. The certificate can also contain information on the distributor. This information gives the purchaser a certain guarantee regarding the honesty of the distributor, since it proves that the latter is known to the legitimate manufacturer.

For example, the information identifying the product can be a photo and a product description, the unique identification number of the product, and the validity code of the product. The photo of the product can advantageously be patterned by a microstructure using the process described in the international patent application PCT/IB02/02686, where the microstructure includes information in the form of text identifying the purchaser, the unique number of the product, and the validity code of the product. The microstructure can also include a product description. In this way, even a certificate printed on non-secured paper on a standard printer cannot easily be copied or modified by a counterfeiter.

The authenticity certificate can also include a check code 45. This code is a complex algorithmic function of the other information present on the certificate. It allows a small group of people working for the legitimate manufacturer to verify the authenticity of certificates without having access to the confidential information of the customers. This algorithmic function constitutes a security rule which must be known only to the group of people responsible for verifying the authenticity of the certificates. This code is therefore not verified by the purchaser.

The encoded information known only to the purchaser (and to the company running a customer loyalty programme) personalises the certificate and thus protects it against copying. It also authenticates the latter, since it is not known to counterfeiters. To this end, the certificate can contain a zone 44 in which is printed an item of information which is known only to the purchaser and to the loyalty programme, but not to the distributor (vendor). In a first form of implementation, this is a confidential word chosen by the purchaser, such as during enrollment in the loyalty programme, and which can be read only by means of a revealer 8, held by the purchaser, who must place it on the encoded part 44 of the certificate provided for this purpose. The purchaser regularly receives a private revealer 8 (which differs from one purchaser to the next) in the context of the loyalty programme. The purchaser verifies the authenticity of the certificate by placing his revealer on the certificate, and then verifying that his confidential word appears. This result can advantageously be obtained by a particular use of the moiré effect as described in patent U.S. Pat. No. 6,249,588, or by visual cryptography as described in patent U.S. Pat. No. 5,488,864.

The superimposition of two repetitive printed structures whose periods are close but slightly different can bring up a third repetitive structure with a higher period. The appearance of this third structure by superimposition of two other structures is called the moiré effect.

In the context of this present invention, this third structure brings up a confidential word that is known only to the purchaser.

In order to view this effect, it is necessary that the one of the structures should be printed on a transparent medium, while the other can be printed on an opaque medium. Preferably, what is referred to as the revealer is generated on a transparent medium, the other medium being called the base element.

The superimposition of the base element and the revealer will bring up the confidential word only if the revealer is used with the appropriate base element. On the other hand, the use of another base element can produce other moiré phenomena.

In this present invention, according to one form of implementation, the information conveyed by the moiré pattern includes:
the confidential code which has to appear. This information, as such, is not specific to the use of the moiré pattern.
the mathematical function used simultaneously for generation of the base element and the revealer. This function is called the transformation function. This can be a sinusoidal function for example.
the parameters of this function (e.g. amplitude and period of the sinusoidal function)

The set of mathematical functions that can be used to generate the base and the revealer is specified in advance. This also applies to all of the parameters of each function and to the range of values allowable for each of these parameters. During the enrollment of a customer in the loyalty programme, he randomly chooses the function and the associated parameters, from all of the valid combinations, meaning that it allows the generation of the base elements and the revealer. After selection of the function and its parameters, the revealer is generated, printed and sent to the customer.

As mentioned above, with each product is associated a unique number that is used to identify it. It is also used to identify the approved manufacturer that made it. The identification number of the product, which is stored in a database of the legitimate manufacturer, is preferably written directly onto the product and onto a label. By “label” is meant any medium supplied with the product, such as its packaging, on which the information identifying the product is printed.

With each unique identification number stored in the product database 14 of the computer system 41 of the legitimate manufacturer is associated a state whose objective is to detect the reuse of unique numbers by counterfeiters. Each number can be in one of the following states:
valid: the product that bears this number has not been sold yet.
invalid: the product that bears this number has been sold, and so the corresponding unique number can no longer be used.

When the products are manufactured by third parties approved by the legitimate manufacturer, holder of the rights on the products, the latter allocates, in advance, ranges of numbers to each approved manufacturer according to the planned production volumes. The approved manufacturer can only use the numbers within the range allocated to it.

Periodically, but no later than when the corresponding product is sent to a distributor (vendor), the approved manufacturer must provide the legitimate manufacturer with a list of the numbers used. Only the numbers supplied to the legitimate manufacturer are considered to be valid. Any product that bears an undeclared number will be considered to be inauthentic in the event of a check.

With each product identification number there is associated a validity code that is used to verify the authenticity of the product number. This validity code is generated in the computer system of the legitimate manufacturer according to secret rules. Thus, this code allows the detection of copied products for which the counterfeiter has created a product number and a validity code. In fact, since it does not know the rules for generation of this code, the code that it has created can be identified as being incorrect.

In order to be able to trace the generation and the use of validity codes, the rules for calculation of the code will be specific to each approved manufacturer. If the importer/wholesaler for which the product is intended is already known at the time of manufacture of the product, then the rules for calculation of the code will also depend on this entity. Thus, this code can be used to authenticate the approved manufacturer to which this code has been supplied, or even the first distributor for which the product is intended.

As illustrated in FIG. 3a, the legitimate manufacturer allocates a range of unique product numbers which the approved manufacturer can use for its production. Before printing the labels and marketing its production, the approved manufacturer must declare its production to the legitimate manufacturer which, in exchange, provides it with the associated validity codes.

In the area of security, the label is advantageously produced on paper that has been made secure, such as by means of a watermark or iridescent inks, which allows an initial idea to be obtained on the authenticity of the product through a visual check. Furthermore, it contains all of the information to allow an electronic check.

The time when the label is printed depends essentially on the information incorporated when it is printed, and in particular if its content varies according to place of sale of the corresponding product.

The information on the label includes the unique product identification number and the associated validity code. If the information is already known at the time of manufacture of the product, the label can also contain the place in which the product is marketed (country or distribution network). In addition, the label contains a barcode allowing an electronic check to be performed on or off the production line. This barcode contains at least the unique product number and the associated validity code.

The purchaser who has enrolled in a loyalty programme receives the unique customer identification information from the legitimate manufacturer or from the official body that represents it. This information is supplied independently of a particular purchase, such as in the form of a customer card. This card contains a number identifying the customer for example, appearing in the form of a barcode. The encoded information known only to the purchaser is either incorporated into the customer card, such as in encoded form in the barcode, or stored in the customer database 4 of the computer system of the legitimate manufacturer or of the body that represents it. This is an item of confidential information which is not known to the distributors, and which varies for each customer.

The purchaser of a product, and holder of a customer card, can ask for a personal authenticity certificate during the purchase of a given product from an approved distributor. Since this certificate combines information associated with the product and the information associated with the purchaser, with the latter coming from the customer database run or authorised by the legitimate manufacturer, it has the following characteristics:
It cannot be generated by a counterfeiter since the latter does not have access to the customer database. Neither can the counterfeiter copy an existing certificate, since the latter is associated with an individual purchaser.
It gives a guarantee to the purchaser that the distributor from which he or she purchases the product is actually an approved distributor:
   It guarantees that the product is authentic.

As shown in FIG. 4, the enrollment of a customer in the computer system is effected either by a user 1 of the company running the customer loyalty programmes, or directly by the future purchaser 10, by connecting to a Web site via the Internet 3. The user enters the customer data 2 into a database 4. These data include, for example, information identifying the customer (surname, first name, etc.), the address, and a code or confidential word chosen by the user and modifiable at any time by the latter.

For each new customer, the computer system generates 6 parameters for the generation of specific moiré patterns, in particular the mathematical function for moiré pattern deformation, the parameters of this function, and the frequency of the moiré pattern. The system thus guarantees that this customer will be the only one to be able, using his personal revealer, to read the personalised encoded part of the certificate that he has requested during a purchase.

The customer card 9 is generated 5 from information contained in the customer database 4. The revealer 8 is generated 7 from moiré pattern deformation parameters stored in the customer database 4. The revealer and the customer card are printed and then sent to the purchaser.

As shown in FIGS. 3a and 3b, the approved manufacturer asks the legitimate manufacturer for a range of product numbers that it will be able to use for its production 11. The legitimate manufacturer allocates such a number range and stores this information in the database of the approved manufacturers 12.

In order to be able to print the labels and sell its production, the approved manufacturer must declare its actual production 13 in order to obtain the validity codes associated with the product numbers actually used. The generation of validity codes 15 depends on parameters that are specific to the approved manufacturer. The codes generated, as well as the product numbers actually used, are stored in the database of the manufactured products 14. The validity codes are returned to the approved manufacturer, which can store them in a local database 16.

Using these validity codes, the approved manufacturer can generate and print labels 19 on paper that has been made secure 18, preferably supplied by the legitimate manufacturer.

As shown in FIG. 2, at the time of purchase, the purchaser 10 gives its customer card 9 to the distributor. The latter reads the barcode 20 printed respectively on the customer card 9 and on the label 19. This information, together with an identifier entered by the distributor, is transmitted over the Internet 3 to the computer system 41 of the legitimate manufacturer, which processes the certificate generation request 21. The generation process begins with verification of the unique product number and the validity code. This code verification 22 consists of:
checking that no certificate request concerning the same product number has been effected previously, by consulting the query database 23.
checking that the validity code of the label is consistent with the product number, by consulting the database of manufactured products 14.

The set of information concerned includes:
the identity of the purchaser, obtained from the customer database 4,
the identity of the distributor, obtained from the distributor database 38,
the product number and the associated validity codes, and the product description obtained from the database of manufactured products 14,
the check code 45 generated by the check code generation process 34, on the basis of the information present on the certificate and the code generation rules stored in a contextual database 35, and
the personalised zone generated by the process for generating the base element of the moiré pattern 33, on the basis of the moiré pattern deformation parameters and the customer confidential information stored in the customer database 4

and is used to select 24 the diverse data used for certificate image generation, such as the information layer 28, the elements of the microstructure 27, the parameters for deformation of this microstructure 26, the background image 25 and the (personalised) encoded part 44.

Determination of the microstructure and the process for the generation of this microstructure and for merging it with the background image are already known as such, and described in international patent application PCT/IB02/02686, and so will not be described in any greater detail in this present application. The microstructure elements 27 are formed from a unique combination of elements incorporating information on the product and the purchaser, so that the microstructure of each certificate issued is unique. The fact that this unique microstructure is merged 30 with the background image, thus creating a certificate background which is different from one ticket to the next, provides a high level of security against the illicit reproduction of certificates by fraudsters. In particular, the process 30 for merging the microstructure does not allow a fraudster to modify the text and the images of the microstructure without destroying the background image. It is also possible to effect a transformation 29 of the microstructure determined by parameters of the formation image process 26 in order to increase the difficulty of illicit generation. For example, the transformation can determine the angle of inclination or the optical deformation of the elements of the microstructure.

On the image with a microstructure, an information layer 28 is superimposed with the check code 45 of the certificate and the personalised encoded part 44 generated by a moiré pattern algorithm, or a visual cryptography algorithm.

The certificate generation process supplies a print file 32 which is returned to the distributor by means of the Internet 3. This file is then printed by the distributor 36 and the certificate thus printed 37 is given to the purchaser 10. The latter checks the authenticity of the certificate by inspecting the personalised part, using its personal revealer 8.

As shown in FIG. 5, as an alternative to the use of a private revealer that employs the moiré effect or visual cryptography, a personalisation of the authenticity certificate based on a control card can also be envisaged.

During enrollment in the loyalty programme, the purchaser receives a control card 42 containing a table of numbers. As this card is confidential, it must be separate from the customer card. For reasons of security, it must be replaced regularly (four time per year, for example). The content of this card varies for each customer. The certificate has a code 43 in the encoded part 44 whose value depends on this table of numbers. It can also depend on other information. For example, it can depend on the product, or on the place of distribution and/or the date of purchase. Inspection of the validity code must nevertheless remain available to any purchaser. Only the purchaser has the information necessary for verification of this code. The validity code 789 of the example presented is deduced from the table by the day in the month of purchase, assuming here that the purchase occurred on 27 January for example.

1. A process for the generation of manufactured product authentication certificates, comprising the following steps:
generation of data identifying each manufactured product in a unique manner, and storage of these data in a product database of the computer system of a legitimate manufacturer of said manufactured product;
storage of data confidential to each purchaser of manufactured products in a customer database;
entry and transmission by means of a global computer network, such as the Internet, during a purchase, of data identifying a manufactured product and a purchaser, in a server system for the generation of authenticity certificates;
verification, in the server system for the generation of authenticity certificates, of the validity of the data identifying said manufactured product;
automatic selection, in the server system for the generation of authenticity certificates, of the information to be incorporated into the authenticity certificate print file, where this information includes confidential data associated with the said purchaser and the data identifying said manufactured product in a unique manner;
generation of a print file of an image of the authenticity certificate with a part that is protected against illicit modification of the authenticity certificate, incorporating at least the said data identifying the said product in a unique manner, and another part that is encoded with the confidential data of the purchaser; and
transmission of the print file to the point of sale of the product or a terminal of the purchaser.

2. A process according to claim 1, wherein the data identifying each product in a unique manner include a unique product identification number and a validity code associated with this identification number which is generated and stored in the computer system of the legitimate manufacturer when manufacture of the product is declared.

3. A process according to claim 1, wherein the information incorporated into the part that is protected against the duplication of the authenticity certificate includes data allowing identification of the distributor of the manufactured product.

4. A process according to claim 1, wherein the protected part of the image of the authenticity certificate is a microstructure with a background image patterned by microstructure elements with the said data identifying the said manufactured product in a unique manner.

5. A process according to claim 4, wherein the background image selected for the microstructure includes a photographic representation of the product.

6. A process according to claim 1, wherein the entry of data identifying the manufactured product is achieved by means of a label accompanying the manufactured product, bearing a barcode that includes at least the unique product identification number and the associated validity code.

7. A process according to claim 6, wherein the label is printed on paper that has been made secure by means of a watermark or an iridescent ink.

8. A process according to claim 1, wherein generation of the encoded part of the authenticity certificate includes the generation of a moiré pattern, with the encoded part being readable by means of a complementary revealer, and the moiré parameters being unique to each certificate and generated in the computer system of the legitimate manufacturer at the time of certificate generation.

9. A process according to claim 1, wherein generation of the encoded part of the authenticity certificate includes the generation of a visual cryptographic structure, with the encoded part being readable by means of a complementary revealer, and the visual cryptographic parameters being unique to each certificate and generated in the computer system of the legitimate manufacturer at the time of certificate generation.

10. A process according to claim 1, wherein during the generation and storage of data identifying each purchaser in the customer database, parameters for the generation of a moiré pattern or visual cryptography structures are generated and stored in the database, these parameters being used for the generation and the printing of the revealer transmitted to the purchaser.

11. A process according to claim 1, wherein the encoded part of the authenticity certificate includes a code corresponding to a code reproduced on a printed table transmitted to the purchaser, with the data of the table being stored in the customer database.
